(19) United States
(12) Patent Application Publication
(10) Pub. No.: US 2007/0282041 A1
(43) Pub. Date: Dec. 6, 2007

(54) Composition for inhibiting formation of gas hydrates

(75) Inventor: Michael J. Jurek, Oak Ridge, NJ (US)

Correspondence Address: INTERNATIONAL SPECIALTY PRODUCTS;Attn: William J. Davis, Esq., Legal Department, Building No. 8-2, 1361 Alps Road, Wayne, NJ, 07470, US

(73) Assignee: ISP INVESTMENTS INC.

(21) Appl. No.: 11/444,722

(22) Filed: Jun. 1, 2006

(51) Int. Cl. C08K 5/15

(52) U.S. Cl. 524/109; 524/386; 524/555

(57) ABSTRACT

A composition for preventing or retarding the formation of gas hydrates or for reducing the tendency of gas hydrates to agglomerate, during the transport of a fluid comprising water and a hydrocarbon, through a conduit, comprising, (a) a polymer which is a homopolymer of N-vinyl caprolactam, or a copolymer of N-vinyl caprolactam, with a comonomer, e.g. N,N-dialkyl-aminoethyl(meth)acrylate, and (b) a synergistic additive therewith which is a cationic or non-ionic surfactant, or a sugar, and mixtures thereof.

### BACKGROUND OF THE INVENTION

1. Field of the Invention

This invention relates to a composition for preventing or retarding the formation of gas hydrates, or for reducing the tendency of such hydrates to agglomerate during the transport of a fluid comprising water and a hydrocarbon through a conduit, and, more particularly, to a composition of a vinyl caprolactam polymer and synergistic additive therewith.

2. Description of the Prior Art

It is well known in the art that formation of gas hydrates in a conduit, e.g. a pipeline, during the transport of liquids, such as oil, and gases, particularly lower hydrocarbons, e.g. methane, ethane, propane, butane and iso-butane, is a serious problem, especially in areas with a low temperature in the winter season or in the sea. Generally these temperatures are so low that gas hydrate formation occurs in the wells, due to the presence of Water unless special steps are taken. For example, insulation around the pipe will decrease the chance of gas hydrate formation; however, if the field is relatively small or far away from the production platform, the costs of using such insulation are too high to make it an economically attractive option. It is also known to add anti-freeze compounds, for example, glycol or methanol, during transport to minimize gas hydrate formation; however, very large quantities of these compounds can be required to be effective.

Representative of the prior art in this field are the following U.S. Pat. Nos. 4,915,176; 5,420,370; 5,432,292; 5,723,524; 5,741,758; 5,874,660; 6,028,233; 6,093,863; 6,096,815; 6,117,929; and 6,180,699; as well as EPA 0526929A1; EPO 0323774A1; Can. Pat. Appln 2,073,577; WO 93/25798; WO 95/17579; Gas Hydrates and Hydrate Prevention 73 GPA Annual Convention, pgs 85-93; WO 96/08456; WO 96/08636; WO 93/25798; EPA 0457375A1 and WO 94/12761.

### SUMMARY OF THE INVENTION

What is described herein is a composition for preventing or retarding the formation of gas hydrates or for reducing the tendency of gas hydrates to agglomerate, during the transport of a fluid comprising water and a hydrocarbon, through a conduit, comprising, (a) a homopolymer of N-vinyl caprolactam, or a copolymer of N-vinyl caprolactam and a comonomer which is an N,N-dialkylaminoethyl(meth)acrylate, and (b) a synergistic additive therewith which is a cationic or non-ionic surfactant, or a sugar, and mixtures thereof.

Preferably the polymer is made in a suitable solvent, e.g. a low molecular weight glycol ether containing an alkoxy group having at least 3 carbon atoms, most preferably, butoxy ethanol, as described in U.S. Pat. No. 6,180,699.

In one embodiment of the invention, the composition includes (a) a homopolymer of polyvinyl caprolactam.

In another embodiment, (a) is a comonomer of poly(caprolactam) and diethylaminoethyl methacrylate.

Suitably (b) is a non-ionic surfactant, preferably a C₂-C₈ N-alkyl pyrrolidone, linear or cyclic, e.g. N-ethyl pyrrolidone, N-octyl pyrrolidone, or N-cyclohexyl pyrrolidone, and most preferably, N-octyl pyrrolidone.

In other embodiments of the invention, (b) is sorbitol, mannitol, fructose and/or sucrose.

In another embodiment, of the invention, (b) is a non-ionic surfactant which includes poly(ethylene glycol) and poly(ethylene oxide-propylene oxide).

These and other features of the invention will be made apparent from the following description thereof.

### DETAILED DESCRIPTION OF THE INVENTION

The composition of the invention includes a homopolymer of vinyl caprolactam and copolymers of vinyl caprolactam, preferably an N,N-dialkyl aminoalkyl methacrylamide, e.g. N,N-dimethylamino propyl methacrylamide; N,N-dialkyl aminoalkyl(meth)acrylate; e.g. N,N-dimethylaminoethyl(meth)acrylate, and quaternized salts thereof, e.g. N-alkyl bromides; and N-alkyl chlorides; and the like.

Preferably the polymer is made in a suitable solvent e.g. BGE, and maintained therein in the composition of the invention as disclosed in U.S. Pat. No. 6,180,699. Less preferably, they are made in another solvent, such as isopropanol solvent, the solvent removed, and the desired glycol ether solvent added. Preferred polymers are low weight average molecular weight polymers, e.g., less than 10,000, e.g. 7,000.

Suitable solvents include low molecular weight glycol ethers containing an alkoxy group having at least 3 carbon atoms, N-methylpyrrolidone (NMP), ethylene glycol, water and blends thereof. Representative glycol ethers include 2-butoxyethanol(ethylene glycol monobutyl ether); propylene glycol butyl ether; (diethylene glycol)monobutyl ether; and 2-isopropoxy-ethanol. 2-Butoxyethanol (BGE) is preferred.

Preferred formulations of the invention include:

Polymer*, BGE solvent, synergist additive, and optionally, solvent 2, (e.g. ethylene glycol) corrosion inhibitor and water. * made in BGE solvent

### Compositions of Invention:

| | |
|---|---|
| Polymer | 0.01–55% suitable |
| | 1.0–40% preferred |
| | 5–30% optimum |
| Synergistic additive | 0.001–10% suitable |
| | 0.01–5% preferred |
| | 0.1–3% optimum |
| Solvent 2 | 0–70% suitable |
| | 2–50% preferred |
| | 5–25% optimum |

### Use Ranges

The composition of the invention, once prepared, is used to treat natural gas containing water at a suitable use rate of 0.05-15 wt. % based on water content, preferably 0.1-10 wt. %, and, optimally 0.20-6 wt. %.

### Experimental

### Equipment

The gas hydrate inhibition tests were conducted in a 500 ml, 316 stainless steel autoclave vessel (hereafter referred to as a “rig”) having a usable volume of 200 ml, equipped with a thermostated cooling jacket, sapphire window, platinum resistant thermometer (PRT), inlet and outlet, and magnetic stirring pellet. The rig was rated up to 400° C. and down to −25° C. Temperature and pressure were data logged, while cell content was visually monitored by a boroscope video camera connected to a time lapsed video recorder. Hydrate formation in the rig was detected using a combination of three methods: visual detection of hydrate crystals, decrease in vessel pressure due to gas uptake and by the temperature exotherm created by heat released during hydrate formation.

### Preparation of Polymer

### EXAMPLE

300 g. of 2-butoxyethanol was charged into a 1-liter resin reaction fitted with a propeller agitator, a reflux condenser, a nitrogen inlet tube and a thermowatch, and heated to 150° C. A monomer pre-mix was prepared by mixing 200 g. of vinyl caprolactam with 4.00 g of di-t-butyl peroxide initiator in a 400-ml beaker. Then the monomer pre-mix was pumped into the reaction kettle over a period of 2 hours. The reaction mixture then was held at 150° C. for 1.5 hours before adding 0.50 g of di-t-butyl peroxide initiator, and held at 150° C. for an additional 3 hours. After cooling to room temperature, the product was a light brown, viscous poly(vinyl caprolactam) (PVCL) in 2-butoxyethanol (BGE) at 40% solids. Residual vinyl caprolactam was 0.9% by GC analysis. The PVCL polymer had a relative viscosity of 1.074 (1% in 2-butoxyethanol), a GPC molecular weight of 1,210 (polyethylene glycol standard), and a cloud point of 42° C.

### Performance Tests

The performance tests were carried out using distilled water as the aqueous phase.

### (1) Blank Tests

Blank tests were performed at a prescribed pressure, e.g. 75, 100 or 125 bar, and at a temperature of 4° C. (subcooling=˜10-12.5° C.). The high water cut mixture was stirred continuously until a hydrate formed.

### (2) Invention Tests

The same tests as described for the blanks were run using various levels of each composition of the invention. The treat rate of the composition was expressed as a “wt % level” based on the water cut.

Data logging was started. The rig was then pressurized to the selected pressure with the test gas and the temperature of the thermostat was set at 4° C. The contents in the rig were then stirred for 48 hours. Throughout the tests, both temperature and pressure were monitored. The rig content was visually monitored by a boroscope video camera.

The test results are shown in Tables 1-3 below. Table 1 shows the results using P(VCL) alone or with octyl pyrrolidone LP-100 as the inhibitor.

TABLE 1

| | | | | | Final | | |
|---|---|---|---|---|---|---|---|
| | | | Induction | | Pressure | | |
| | Use Rate | Wt % | time (min) | | (bar) | | |
| Sample | Wt % Polymer | Additive | Rig 1 | Rig 2 | Rig 1 | Rig 2 | Results |
| Blank - DI water* | — | — | 2 | | 24 | | hard |
| | | | | | | | hydrates |
| P(VCL)** high | 1.0% in | — | 2 | | 62 | | foam, soft |
| MW | ethanol | | | | | | hydrates |
| P(VCL)** high | 1.0% in | — | | 480 | | 58 | foam, |
| MW | methanol | | | | | | hydrates |
| —*** | — | 0.1% | 60 | 100 | 64 | 51 | soft |
| | | LP-100 | | | | | hydrates |
| P(VCL)*** | 1.50% in | 0.1% | 175 | | 42 | | foam, soft |
| | BGE | LP-100 | | | | | hydrates |
| P(VCL)*** | 1.5% | — | 225 | 130 | 58 | 61 | hard |
| | Formulation 1 | | | | | | hydrates |
| P(VCL)*** | 1.5% | 0.1% | 150 | 1400 | 49 | 71 | no |
| | Formulation 1 | LP-100 | | | | | hydrates |
| P(VCL)*** | 3.0% | 0.1% | | 2880 | | 71 | no |
| | Formulation 1 | LP-100 | | | | | hydrates |

*initial pressure - 50 bar
**initial pressure - 75 bar
***initial pressure - 100 bar

Tables 2 and 3 shows the results using a copolymer of P(VCL) and N,N-dimethyl aminoethyl methacrylate (DEAEMA) as the comonomer, alone or with octyl pyrrolidone, to reduce hydrate formation.

TABLE 2

| | | | | | Final | | |
|---|---|---|---|---|---|---|---|
| | Use Rate | | Induction | | Pressure | | |
| | Wt % | Wt % | time (min) | | (bar) | | |
| Sample | Polymer | Additive | Rig 1 | Rig 2 | Rig 1 | Rig 2 | Results |
| P(VCL/DEAEMA) | 1.0% | * | 524 | 2 | 53 | 27 | hard, solid |
| | Formulation 2 | | | | | | hydrates |
| P(VCL/DEAEMA) | 2.5% | * | 290 | | 59 | | hard, |
| | Formulation 2 | | | | | | hydrates |
| P(VCL/DEAEMA) | 3.0% | * | 650 | | 61 | | hard, solid |
| | Formulation 2 | | | | | | hydrates |
| | — | 0.1% | | 60 | | 65 | very soft |
| | | LP-100* | | | | | hydrates |
| | | 0.05% | | 1 | | 63 | very soft |
| | | LP-100* | | | | | hydrates |
| Blank | — | * | 4 | 7 | 47 | 42 | solid |
| | | | | | | | hydrate |
| P(VCL/DEAEMA) | 3.0% | 0.1% | 2800 | 2880 | 87 | 74 | no |
| | Formulation 2 | LP- | | | | | hydrates |
| | | 100*** | | | | | |
| P(VCL/DEAEMA) | 3.0% | 0.05% | | 3050 | | 78 | foam, |
| | Formulation 2 | LP- | | | | | minimal |
| | | 100*** | | | | | hydrates |

*initial pressure - 75 bar
***initial pressure - 100 bar

Table 3 show the test results using P(VCL/DEAMA) copolymer alone, or with a synergistic additive therewith. The results show the efficacy of the composition of the invention in reducing hydrate formation.

TABLE 3

| | | | | | Final | | |
|---|---|---|---|---|---|---|---|
| | Use Rate | | Induction | | Pressure | | |
| | Wt % | Wt % | time (min) | | (bar) | | |
| Sample | Polymer | Additive | Rig 1 | Rig 2 | Rig 1 | Rig 2 | Results |
| P(VCL/DEAEMA)* | 1.0% in | — | | 524 | | 53 | hard |
| | Formulation 2 | | | | | | hydrates |
| P(VCL/DEAEMA)* | 2.5% in | — | 290 | | 59 | | hard |
| | Formulation 2 | | | | | | hydrates |
| P(VCL/DEAEMA)* | 1.5% in | 0.5% | | 1440 | | 75 | no |
| | Formulation 2 | sorbitol | | | | | hydrates |
| P(VCL/DEAEMA)* | 1.50% | 0.5% | 2 | 15 | 56 | 61 | foam, soft |
| | | glycerol | | | | | hydrates |
| P(VCL/DEAEMA)* | 2.50% | 0.5% | | 370 | | 60 | hydrate |
| | | glycerol | | | | | chunks |
| P(VCL/DEAEMA)* | 2.50% | 0.5% | | 730 | | 62 | hard |
| | | propylene | | | | | hydrates |
| | | glycol | | | | | |
| P(VCL/DEAEMA)* | 1.50% | 0.5% | 1440 | | 70 | | no |
| | | sorbitol | | | | | hydrates |
| P(VCL/DEAEMA)* | 1.50% | 1.0% | | 1440 | | 75 | no |
| | | sorbitol | | | | | hydrates |
| P(VCL/DEAEMA)* | 1.50% | 1.0% | 1480 | | 74 | | no |
| | | mannitol | | | | | hydrates |
| P(VCL/DEAEMA)* | 2.50% | 0.5% | 1440 | | 70 | | no |
| | | sorbitol | | | | | hydrates |
| P(VCL/DEAEMA)*** | 1.50% | 1.5% | | 2000 | | 84 | small |
| | | sorbitol | | | | | amount |
| | | | | | | | hydrates |
| P(VCL/DEAEMA)*** | 1.5% in | 0.5% | | 1280 | | 87 | soft |
| | Formulation 2 | sorbitol | | | | | hydrates |
| P(VCL/DEAEMA)*** | 1.5% in | 0.5% | | 1440 | | 75 | no |
| | Formulation 2 | sorbitol | | | | | hydrates |
| P(VCL/DEAEMA)*** | 1.5% in | 1.5% | 2600 | 2880 | 82 | 91 | some soft |
| | Formulation 2 | sorbitol | | | | | hydrates |

*initial pressure - 75 bar
***initial pressure - 100 bar

While the invention has been described with particular reference to certain embodiments thereof, it will be understood that changes and modifications may be made which are within the skill of the art. Accordingly, it is intended to be bound only by the following claims, in which:

What is claimed is:

1. A composition for preventing or retarding the formation of gas hydrates or for reducing the tendency of gas hydrates to agglomerate, during the transport of a fluid comprising water and a hydrocarbon, through a conduit, comprising, (a) a homopolymer of N-vinyl caprolactam, or a copolymer of vinyl caprolactam with an N,N-dialkylaminoethyl(meth)acrylate and quats thereof, and mixtures thereof and (b) a synergistic additive therewith which is a cationic or non-ionic surfactant, or a sugar, and mixtures thereof.

2. A composition according to claim 1 which includes a solvent which is a low molecular weight glycol ether containing an alkoxy group having at least 3 carbon atoms.

3. A composition according to claim 2 wherein (a) said homopolymer is polyvinyl caprolactam made in butoxyethanol.

4. A composition according to claim 2 wherein (a) said copolymer is poly(caprolactam)/diethylaminoethyl methacrylate made in butoxyethanol.

5. A composition according to claim 1 wherein (b) said non-ionic surfactant is a C₂-C₈ N-alkyl pyrrolidone, linear or cyclic, e.g. N-ethyl pyrrolidone, N-octyl pyrrolidone, or N-cyclohexyl pyrrolidone.

6. A composition according to claim 1 wherein (b) said non-ionic surfactant is N-octyl pyrrolidone.

7. A composition according to claim 1 wherein (b) is sorbitol, mannitol, fructose and/or sucrose.

8. A composition according to claim 1 wherein (b) said non-ionic surfactant is poly(ethylene glycol), or polyethylene oxide-propylene oxide.
